(19) United States
(12) Patent Application Publication
(10) Pub. No.: US 2012/0254288 A1
(43) Pub. Date: Oct. 4, 2012

(54) RECOMPOSITING AN RUI IN REAL-TIME

(75) Inventors: Stephane Lejeune, San Diego, CA (US); Graham Clift, El Cajon, CA (US)

(73) Assignee: SONY CORPORATION, Tokyo (JP)

(21) Appl. No.: 13/073,807

(22) Filed: Mar. 28, 2011

(51) Int. Cl. G06F 15/16

(52) U.S. Cl. 709/203

(57) ABSTRACT

A method of recompositing or recomposing a remote user interface in real-time includes a server device determining network information or conditions and modifying the remote user interface based on the network information. One aspect of modifying the remote user interface includes the server device increasing or decreasing the amount of detail of the remote user interface. Another aspect of modifying the remote user interface includes generating several versions of the remote user interface of varying detail and selecting one of the versions based on the network information. A rendering device is then able to display the modified remote user interface without causing a disruption in the network.

### FIELD OF THE INVENTION

The present invention relates to the field of remote user interfaces. More specifically, the present invention relates to recompositing a remote user interface in real-time.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

The expansion of residential networks to include a multiplicity of devices that can share files asynchronously and connect to the Internet through residential gateways was facilitated by the de-facto standard use of wired and wireless ethernet connectivity. Asynchronous sharing then started to give way to buffered streaming of video as bandwidth availability improved. This was closely followed by real time streaming. Networks employ quality of service to manage bandwidth resource and Universal Plug and Play (UPnP) to perform discovery and compatibility of compressed video content. Video UPnP also defines remote user input operation like play, stop and rewind so that video control as well as video display is able to be performed remotely. Also, provisions were made to support graphical transfer of a remote user interface, but no implementations on the market have made use of this. UPnP allowed for many different standards of compressed video, but does not, however, certify that a client supported the relevant decoder. Digital Living Network Alliance (DLNA) is a standards body formed to provide certified device compatibility for a specific subset of UPnP implementations. It also defined the role of media servers, renderers, adapters, players and controllers.

A standard, referred to as Remote User Interface (RUI or Remote UI) is being developed to allow devices to operate each other and provide the user with a user interface that is configured appropriately for a device being used to control another device. For example, a user interface for a 46″ wide television is not likely to appear properly on a mobile phone which has a display of 2″. The Remote UI standard is a web-based protocol and framework for remote user interface on UPnP Networks and the Internet. The standard allows a UPnP-capable home network device to provide its interface (display and control options) as a web page to display on any other device coupled to the home network.

There are no well defined and widely accepted UPnP implementations for graphical RUI. One option, which has been backed by the UPnP Forum, is a browser based implementation known as CEA2014. The network client browser is considered to be heavy in flash, memory and/or processor requirements (‘thick’ client), whereas the network server application performs simple encapsulation of XML (‘thin’ server). In some situations this may be acceptable, like the case when rendering is performed by a personal computer and the application is run on a small mobile device, or a low end processing device, like a network router.

However, in the case of the home network where the rendering is done by a high definition TV, a Blu-Ray® player, a picture frame or a gaming machine, the use of a browser for RUI has some disadvantages. Firstly, a browser adds to the already substantial memory requirements of the renderers and so for these cost sensitive consumer electronics devices it may not be viable. Secondly, the processing speed requirements for a responsive experience are not going to be provided by the current range of devices available. And thirdly, the browser interface lends itself well to mouse and keyboard control, but is not necessarily the ideal format for a limited button remote control.

Also, the home network is able to include graphics applications built into game machines, video players, dongles and intelligent remotes on the low end, with cable boxes, cloud servers and multimedia PCs on the high end. To shoehorn all of these into one UPnP standard, it is clear that reach will be limited. In some cases substantial effort of rewriting or translation of the graphics application might be needed in order to fit the browser framework.

Another example of a proposed RUI is being provided through the RVU alliance. The RVU alliance was initiated by DirectTV in order to provide a pixel accurate remotely rendered version of their satellite decoder user interface. Unlike the browser based RUI, RVU uses a low level protocol that manipulates the graphics card framebuffer layers more directly. Instead of the script type messages that CEA2014 uses, RVU breaks up elements of the graphics into images that can be sent compressed or uncompressed over the network to be composited in the renderer's screen buffers or off screen buffers as needed. Simple bit commands are sent over the network to allow the images to be stretched, cut and alpha-blended on the renderer side. This type of RUI would be considered a thin network client and thick network server because most of the computation effort would be with the application. Also, because most actions involve sending image data, this type of RUI uses a lot of network resources.

The advantage of RVU is that the low level graphics operations are able to be supported by all graphics cards quite easily and is not directly dependent on the type of application to be able to function. However, sometimes performance is a key parameter in usability, and as such the network load and network server performance could severely limit how useful the protocol is. RVU is especially vulnerable where complete screen refreshes are needed often, like 3D rotations of a view. A browser approach could handle this more simply through scripts of simple rotation commands. Another similar limitation is when the application is providing remote graphics to multiple renderers, and causes the application processor to run short of the necessary MIPS to perform adequately.

### SUMMARY OF THE INVENTION

A method of recompositing or recomposing a remote user interface in real-time includes a server device determining network information or conditions and modifying the remote user interface based on the network information. One aspect of modifying the remote user interface includes the server device increasing or decreasing the amount of detail of the remote user interface. Another aspect of modifying the remote user interface includes generating several versions of the remote user interface of varying detail and selecting one of the versions based on the network information. A rendering device is then able to display the modified remote user interface without causing a disruption in the network.

In one aspect, a method of recomposing a remote user interface in real-time comprises determining network information, modifying remote user interface data into modified remote user interface data based on the network information, sending the modified remote user interface data to a rendering device and rendering the modified remote user interface data on the rendering device. The method further comprises attempting to send the remote user interface data to the rendering device, triggering a server device to determine the network information. The network information comprises a network condition. The network information comprises at least one of network traffic, a network configuration and device information. Modifying the remote user interface data comprises increasing or decreasing an amount of data of the remote user interface data. Decreasing the amount of the data of the remote user interface data includes deleting at least a portion of the remote user interface data. Decreasing the amount of the data of the remote user interface data includes lowering the quality of the remote user interface data. Modifying the remote user interface data comprises generating a plurality of versions of the remote user interface data containing varying amounts of data. A first version includes a high quality and highest amount of the data, a second version includes a medium quality and a middle amount of the data and a third version includes a lowest quality and a lowest amount of data. The server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a network of devices comprises a server device for determining network information and processing remote user interface data based on the network information, one or more source devices for sending the remote user interface data to the server device and one or more rendering devices for rendering the remote user interface data received from the server device. The server device is discovered by the one or more source devices and the one or more rendering devices. The processing of the remote user interface data comprises recompositing the remote user interface data. The remote user interface data is recomposited in real-time. The server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a system programmed in a controller in a device comprises a determining module for determining network information and a communicating module for communicating a recomposited remote user interface to a second device. The network information comprises at least one of network traffic, a network configuration and device information. The recomposited remote user interface is processed based on the network information. The recomposited remote user interface is processed by removing complexity. The recomposited remote user interface is processed by generating a plurality of remote user interfaces of varying complexity and selecting one of the remote user interfaces based on the network information.

In yet another aspect, a server device comprises a memory for storing an application, the application for determining network information, modifying remote user interface data into modified remote user interface data based on the network information, sending the modified remote user interface data to a rendering device and a processing component coupled to the memory, the processing component for processing the application. The network information comprises a network condition. The network information comprises at least one of network traffic, a network configuration and device information. Modifying the remote user interface data comprises increasing or decreasing an amount of data of the remote user interface data. Decreasing the amount of the data of the remote user interface data includes deleting at least a portion of the remote user interface data. Decreasing the amount of the data of the remote user interface data includes lowering the quality of the remote user interface data. Modifying the remote user interface data comprises generating a plurality of versions of the remote user interface data containing varying amounts of data. A first version includes a high quality and highest amount of the data, a second version includes a medium quality and a middle amount of the data and a third version includes a lowest quality and a lowest amount of data.

### BRIEF DESCRIPTION OF THE DRAWINGS

FIG. 1 illustrates a block diagram of a network of devices implementing a method of recompositing an RUI in real-time according to some embodiments.

FIG. 2 illustrates a flowchart of a method of utilizing a server device to recomposite an RUI in real-time according to some embodiments.

FIG. 3 illustrates a block diagram of an exemplary computing device to recomposite an RUI according to some embodiments.

### DETAILED DESCRIPTION OF THE PREFERRED EMBODIMENT

Recompositing a Remote User Interface (Remote UI or RUI) in real-time based on network performance utilizes network performance feedback to adjust or resend the RUI to a client/end device such as a rendering device.

An RUI server monitors network performance and adjusts by increasing or decreasing the detail contained in the RUI. The adjustment is such that the RUI data is able to be transmitted over the network to the received device without information loss. The user is able to benefit by being able to make RUI choices regardless of network performance. The network also benefits as the RUI server reduces the congestion on the network by adapting to network conditions.

The RUI server is able to employ a number of network monitoring techniques to determine the condition of the network. These techniques are able to include some or all of, and are not limited to, source generated diagnostics such a “ping,” client feedback such as packet loss, and network system protocols such as TR069 diagnostics. Based on the performance of the network, the RUI server will limit the data rate of the RUI data to the client device. The RUI server is able to choose any method to generate the appropriate data rate. Examples of methods include:

1) Real-time recompositing of the user interface. Based on the available data rate of the network, the server modifies the amount of information to be sent. For example, fonts are able to be changed to a lower resolution, video streams are able to be downscaled and background deemed unessential is able to be removed.

2) The RUI server is able to contain multiple renderings of the same user interface. Each rendering is optimized for a maximum data rate on the network. The RUI server then chooses the appropriate rendering for transmission.

3) A combination of #1 and #2.

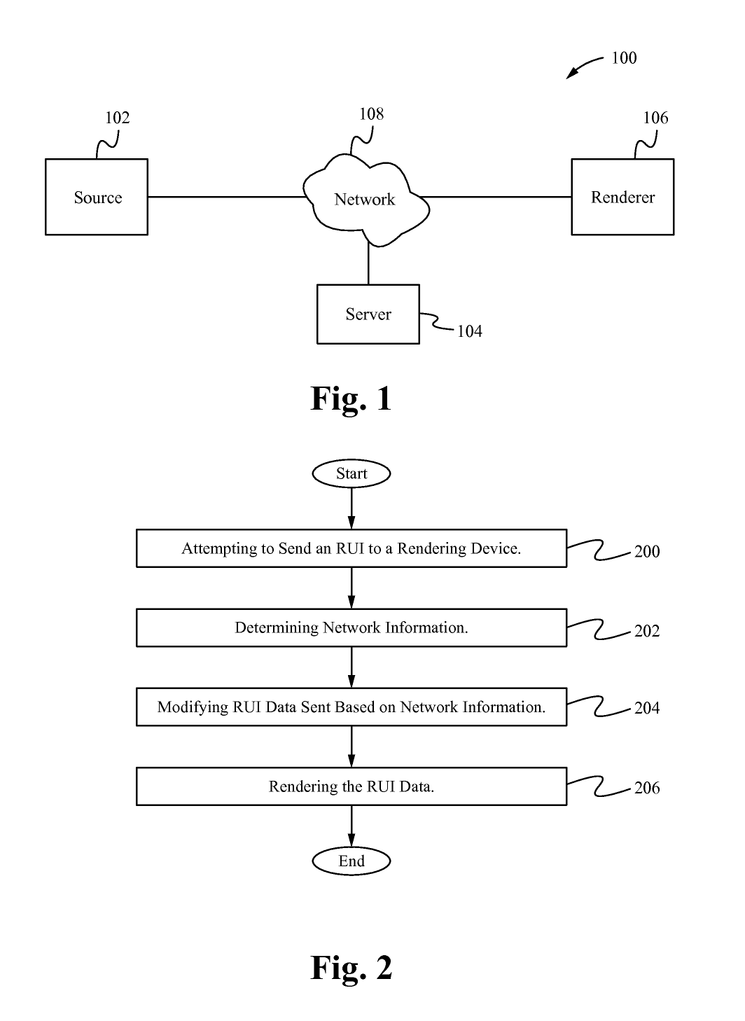

FIG. 1 illustrates a block diagram of a network of devices implementing a method of recompositing (also referred to as recomposing) an RUI in real-time according to some embodiments. The network of devices 100 includes one or more gateway or source devices 102 coupled to a server device 104 and a renderer (e.g. a television) 106. In some embodiments, the source device 102, the server device 104 and the renderer 106 are coupled directly, and in some embodiments, the source device 102, the server device 104 and the renderer 106 are coupled through a network 108. The network 108 is able to be any type of network including, but not limited to, a LAN, a WAN, the Internet, a cellular network, a wireless network, a wired network and/or any combination thereof.

The source device 102 is any device that sends RUI data such as RUI commands to a renderer 106. In some embodiments, the RUI data is sent to a server device 104 which processes the RUI data and then sends the processed data to the renderer 106. In some embodiments, the source device 102 also receives processed RUI data from the server device 104.

The server device 104 is any device that is able to analyze the network 108 including, but not limited to, bandwidth capabilities, processing capabilities, network configuration and other qualities/conditions of the network 108. Based on the analysis, the server device 104 modifies the amount of information sent to the renderer 106 and/or contains multiple renderings of a user interface and sends the appropriate user interface based on the network information. In some embodiments, the server device 104 processes the RUI data from the source device 102, for example, by generating multiple renderings of the RUI and selecting one of the renderings to be sent to the renderer 106.

The renderer 106 is any device that is able to render and display the RUI data, for example, a television displaying an RUI.

For example, in operation, the server device 104 determines the RUI data sent to the renderer 106. The server device 104 is able to direct the source device 102 to send a higher or lower quality RUI depending on the network information such as network conditions. The server device 104 is able to receive RUI data and modify the RUI data to send to the renderer. The server device 104 is able to store different versions of varying quality of an RUI and send a version of the RUI to the renderer 106 based on the network conditions.

FIG. 2 illustrates a flowchart of a method of utilizing a server device to recomposite an RUI in real-time according to some embodiments. In the step 200, a source device attempts to send an RUI to a rendering device. In some embodiments, a server device detects that the source device is communicating with the rendering device. In some embodiments, attempting to send the RUI includes sending the RUI to the server device. In the step 202, a server device determines network information such as network conditions. As described herein, network information includes information such as network traffic, network configurations and other information useful for determining the network conditions/capabilities. In the step 204, the server device modifies the RUI data sent based on the network information. The RUI data is sent to the rendering device and/or the source device. In some embodiments, the server device modifies the amount of information to be sent by removing some of the RUI information or modifying the RUI information in another way. In some embodiments, the server device generates/contains multiple renderings of the RUI and sends the appropriate rendering based on the network information. The multiple renderings each contain varying amounts of data, for example, a high quality version, a medium quality version and a low quality version. In some embodiments, the server device performs a combination of modifying the renderings and generating multiple renderings. In some embodiments, the RUI communicates with the source device to send a specified RUI. In the step 206, the rendering device renders the RUI (e.g. displays the RUI on a television with supplemental information from the metadata). In some embodiments, rendering includes simply displaying a video on a device, and in some embodiments, rendering includes further processing of a video and then displaying the video. Although specific steps are described, in some embodiments, fewer or more steps are included, and/or the order of the steps is able to be changed. An additional possible step includes discovery of the server device by the source device and the rendering device.

In some embodiments, the RUI data is able to be communicated directly from the source device to the rendering device, and in some embodiments, the RUI data is communicated to the server device and then to the rendering device.

In an exemplary network, a user uses a mobile device to remotely control a television via a network including a server capable of recompositing an RUI in real-time. When the user sends a command to generate an RUI, the server determines the specifications of the RUI to be generated using network information. For example, if there is heavy network traffic, a lower bandwidth RUI is communicated. However, if the network is capable, a high bandwidth RUI is communicated. The RUI is communicated to the television and/or the mobile device, and the RUI is rendered at the television and/or at the mobile device depending on the RUI or the command.

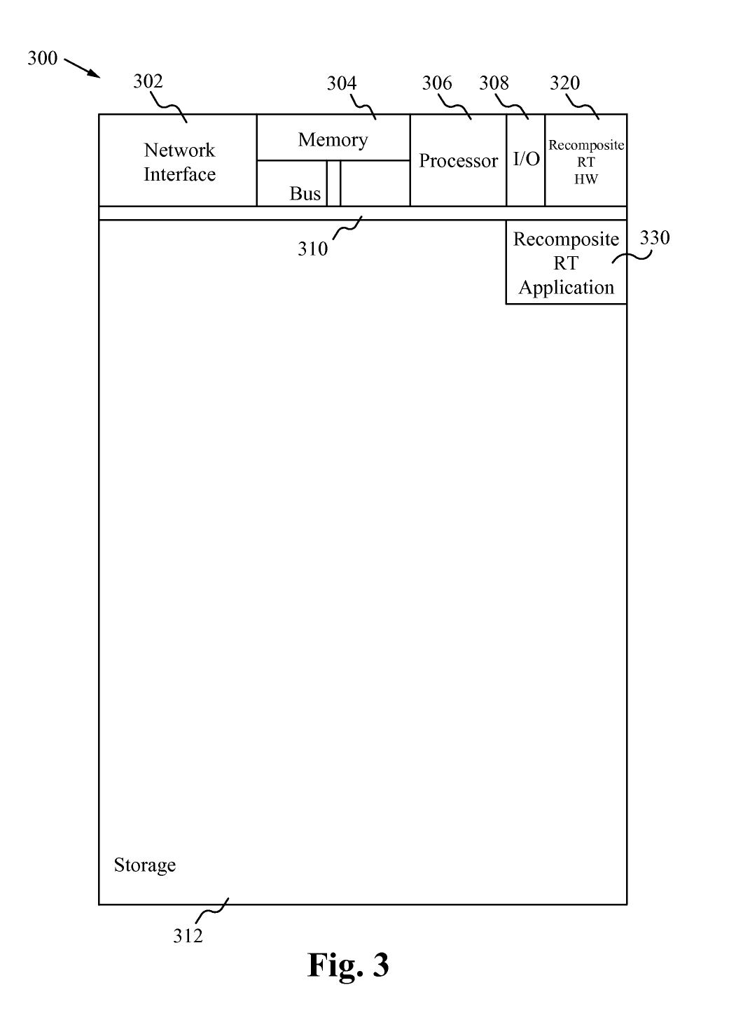

FIG. 3 illustrates a block diagram of an exemplary computing device 300 to recomposite an RUI in real-time according to some embodiments. The computing device 300 is able to be used to acquire, store, compute, communicate and/or display information. For example, the computing device 300 is able to receive, generate, store, and modify an RUI. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, Blu-ray®, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. Recompositing application(s) 330 used to perform the real-time RUI recompositing method are likely to be stored in the storage device 312 and memory 304 and processed as applications are typically processed. More or less components shown in FIG. 3 are able to be included in the computing device 300. In some embodiments, real-time RUI recompositing hardware 320 is included. Although the computing device 300 in FIG. 3 includes applications 330 and hardware 320, the real-time RUI recompositing method is able to be implemented on a computing device in hardware, firmware, software or any combination thereof. For example, in some embodiments, the real-time RUI recompositing applications 330 are programmed in a memory and executed using a processor. In another example, in some embodiments, the real-time RUI recompositing hardware 320 is programmed hardware logic including gates specifically designed to implement the real-time RUI recompositing method.

In some embodiments, the real-time RUI recompositing application(s) 330 include several applications and/or modules. As described herein, the modules are able to include a determining module for determining network information and a communicating module for communicating a selected RUI data. In some embodiments, modules include one or more sub-modules as well. In some embodiments, fewer or additional modules are able to be included.

Examples of suitable computing devices for the server device, source device and rendering device include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, a television, a home entertainment system or any other suitable computing device. In some embodiments, a computing device is able to include intelligent appliances such as a refrigerator, a toaster, a toaster oven and a microwave, where the appliances are able to process and/or present information.

To utilize the method of recompositing an RUI in real-time, a user incorporates a server device on a network with a source device and a renderer. When the user issues an RUI command, the server device processes the RUI data, and based on the network conditions, the appropriate RUI data is sent to the renderer and/or source device. In some embodiments, the RUI data is pre-processed by the server device in anticipation of commands.

In operation, the method of recompositing an RUI implements a server device with a source device and a renderer. The server device receives RUI data from the source device and processes the RUI data. The server device determines how much information of the RUI data to send based on network conditions. The server device is able to modify the RUI data such as removing background information, generating varying versions of the RUI data and/or a combination of the two. The renderer and/or the source device are then able to display the received RUI data. By modifying the amount of data sent, the user is able to experience smoother operation of the network. Further, since the RUI is generated with less data or a server generates different versions, in some embodiments pre-generated versions, of the RUI to be selected, the RUI is able to be recomposited in real-time.

The devices implemented within the network described herein are able to implement Digital Living Network Alliance (DLNA) standard as well.

### Some Embodiments of Recompositing an RUI in Real-Time

1. A method of recomposing a remote user interface in real-time comprising:
   a. determining network information;
   b. modifying remote user interface data into modified remote user interface data based on the network information;
   c. sending the modified remote user interface data to a rendering device; and
   d. rendering the modified remote user interface data on the rendering device.
2. The method of clause 1 further comprising attempting to send the remote user interface data to the rendering device, triggering a server device to determine the network information.
3. The method of clause 1 wherein the network information comprises a network condition.
4. The method of clause 1 wherein the network information comprises at least one of network traffic, a network configuration and device information.
5. The method of clause 1 wherein modifying the remote user interface data comprises increasing or decreasing an amount of data of the remote user interface data.
6. The method of clause 5 wherein decreasing the amount of the data of the remote user interface data includes deleting at least a portion of the remote user interface data.
7. The method of clause 5 wherein decreasing the amount of the data of the remote user interface data includes lowering the quality of the remote user interface data.
8. The method of clause 1 wherein modifying the remote user interface data comprises generating a plurality of versions of the remote user interface data containing varying amounts of data.
9. The method of clause 8 wherein a first version includes a high quality and highest amount of the data, a second version includes a medium quality and a middle amount of the data and a third version includes a lowest quality and a lowest amount of data.
10. The method of clause 1 wherein the server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
11. A network of devices comprising:
   a. a server device for determining network information and processing remote user interface data based on the network information;
   b. one or more source devices for sending the remote user interface data to the server device; and
   c. one or more rendering devices for rendering the remote user interface data received from the server device.
12. The network of devices of clause 11 wherein the server device is discovered by the one or more source devices and the one or more rendering devices.
13. The network of devices of clause 11 wherein the processing the remote user interface data comprises recompositing the remote user interface data.
14. The network of devices of clause 11 wherein the remote user interface data is recomposited in real-time.
15. The network of devices of clause 11 wherein the server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
16. A system programmed in a controller in a device comprising:
   a. a determining module for determining network information; and
   b. a communicating module for communicating a recomposited remote user interface to a second device.
17. The system of clause 16 wherein the network information comprises at least one of network traffic, a network configuration and device information.
18. The system of clause 16 wherein the recomposited remote user interface is processed based on the network information.
19. The system of clause 16 wherein the recomposited remote user interface is processed by removing complexity.
20. The system of clause 16 wherein the recomposited remote user interface is processed by generating a plurality of remote user interfaces of varying complexity and selecting one of the remote user interfaces based on the network information.
21. A server device comprising:
   a. a memory for storing an application, the application for:
      i. determining network information;
      ii. modifying remote user interface data into modified remote user interface data based on the network information; and
      iii. sending the modified remote user interface data to a rendering device; and
   b. a processing component coupled to the memory, the processing component for processing the application.
22. The server device of clause 21 wherein the network information comprises a network condition.
23. The server device of clause 21 wherein the network information comprises at least one of network traffic, a network configuration and device information.
24. The server device of clause 21 wherein modifying the remote user interface data comprises increasing or decreasing an amount of data of the remote user interface data.
25. The server device of clause 24 wherein decreasing the amount of the data of the remote user interface data includes deleting at least a portion of the remote user interface data.
26. The server device of clause 24 wherein decreasing the amount of the data of the remote user interface data includes lowering the quality of the remote user interface data.
27. The server device of clause 21 wherein modifying the remote user interface data comprises generating a plurality of versions of the remote user interface data containing varying amounts of data.
28. The server device of clause 27 wherein a first version includes a high quality and highest amount of the data, a second version includes a medium quality and a middle amount of the data and a third version includes a lowest quality and a lowest amount of data.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of recomposing a remote user interface in real-time comprising:
a. determining network information;
b. modifying remote user interface data into modified remote user interface data based on the network information;
c. sending the modified remote user interface data to a rendering device; and
d. rendering the modified remote user interface data on the rendering device.

2. The method of claim 1 further comprising attempting to send the remote user interface data to the rendering device, triggering a server device to determine the network information.

3. The method of claim 1 wherein the network information comprises a network condition.

4. The method of claim 1 wherein the network information comprises at least one of network traffic, a network configuration and device information.

5. The method of claim 1 wherein modifying the remote user interface data comprises increasing or decreasing an amount of data of the remote user interface data.

6. The method of claim 5 wherein decreasing the amount of the data of the remote user interface data includes deleting at least a portion of the remote user interface data.

7. The method of claim 5 wherein decreasing the amount of the data of the remote user interface data includes lowering the quality of the remote user interface data.

8. The method of claim 1 wherein modifying the remote user interface data comprises generating a plurality of versions of the remote user interface data containing varying amounts of data.

9. The method of claim 8 wherein a first version includes a high quality and highest amount of the data, a second version includes a medium quality and a middle amount of the data and a third version includes a lowest quality and a lowest amount of data.

10. The method of claim 1 wherein the server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

11. A network of devices comprising:
a. a server device for determining network information and processing remote user interface data based on the network information;
b. one or more source devices for sending the remote user interface data to the server device; and
c. one or more rendering devices for rendering the remote user interface data received from the server device.

12. The network of devices of claim 11 wherein the server device is discovered by the one or more source devices and the one or more rendering devices.

13. The network of devices of claim 11 wherein the processing the remote user interface data comprises recompositing the remote user interface data.

14. The network of devices of claim 11 wherein the remote user interface data is recomposited in real-time.

15. The network of devices of claim 11 wherein the server device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

16. A system programmed in a controller in a device comprising:
a. a determining module for determining network information; and
b. a communicating module for communicating a recomposited remote user interface to a second device.

17. The system of claim 16 wherein the network information comprises at least one of network traffic, a network configuration and device information.

18. The system of claim 16 wherein the recomposited remote user interface is processed based on the network information.

19. The system of claim 16 wherein the recomposited remote user interface is processed by removing complexity.

20. The system of claim 16 wherein the recomposited remote user interface is processed by generating a plurality of remote user interfaces of varying complexity and selecting one of the remote user interfaces based on the network information.

21. A server device comprising:
a. a memory for storing an application, the application for:
i. determining network information;
ii. modifying remote user interface data into modified remote user interface data based on the network information; and
iii. sending the modified remote user interface data to a rendering device; and
b. a processing component coupled to the memory, the processing component for processing the application.

22. The server device of claim 21 wherein the network information comprises a network condition.

23. The server device of claim 21 wherein the network information comprises at least one of network traffic, a network configuration and device information.

24. The server device of claim 21 wherein modifying the remote user interface data comprises increasing or decreasing an amount of data of the remote user interface data.

25. The server device of claim 24 wherein decreasing the amount of the data of the remote user interface data includes deleting at least a portion of the remote user interface data.

26. The server device of claim 24 wherein decreasing the amount of the data of the remote user interface data includes lowering the quality of the remote user interface data.

27. The server device of claim 21 wherein modifying the remote user interface data comprises generating a plurality of versions of the remote user interface data containing varying amounts of data.

28. The server device of claim 27 wherein a first version includes a high quality and highest amount of the data, a second version includes a medium quality and a middle amount of the data and a third version includes a lowest quality and a lowest amount of data.
